(19) United States
(12) Patent Application Publication
(10) Pub. No.: US 2026/0305900 A1
(43) Pub. Date: Oct. 8, 2026

(54) APPARATUS AND METHOD FOR CONTROLLING A CLEANING ROBOT

(71) Applicant: BSH Hausgeräte GmbH, München (DE)

(72) Inventors: Kristina DANIEL, Bad Neustadt (DE); Frank SCHNITZER, Bad Neustadt (DE); Dominik SCHREINER, Kalbach (DE)

(21) Appl. No.: 19/634,150

(22) Filed: Mar. 31, 2026

(30) Foreign Application Priority Data
Apr. 3, 2025 (DE) 102025113163.5

(51) Int. Cl. A47L 11/40; A47L 9/00; A47L 9/28; G05D 1/648; A47B 96/00; G05D 105/10

(52) U.S. Cl. CPC A47L 11/4011; A47L 9/0063; A47L 9/2836; A47L 11/4091; G05D 1/648; A47B 96/00; A47L 2201/02; G05D 2105/10

(57) ABSTRACT

An apparatus and a method for controlling a cleaning robot. The cleaning is embodied to be arranged in a service station. The service station has an access opening, which allows the cleaning robot to travel via the access opening towards the service station or away from the service station. The apparatus ascertains, based on one or more sensors, sensor data in relation to a body part of a user approaching the access opening and/or in relation to a force acting on a gate arranged at the access opening. The cleaning robot is operated in dependence on the sensor data.

### CROSS-REFERENCE TO RELATED APPLICATION

This application claims the priority, under 35 U.S.C. § 119, of German Patent Application DE 10 2025 113 163.5, filed April 3, 2025; the prior application is herewith incorporated by reference in its entirety.

### FIELD AND BACKGROUND OF THE INVENTION

The invention relates to an apparatus and a corresponding method for controlling a cleaning robot, in particular a cleaning robot arranged in a service station.

A cleaning robot can be used to autonomously clean a surface, in particular the floor in a home. Between operating phases the cleaning robot can be arranged in or at a service station, at which one or more service functions for regenerating the cleaning robot can be induced. Exemplary service functions are: charging of the electrical energy store of the cleaning robot, and/or emptying, in particular cleaning by suction removal, the collection container of the cleaning robot, and/or cleaning of one or more mopping elements of the cleaning robot.

### SUMMARY OF THE INVENTION

For reasons of space, the service station for a cleaning robot can be arranged at a location, for example in the pedestal region of a kitchen cupboard, which is relatively difficult for a user of the cleaning robot to access. It is one of the objects of the present invention to address the technical problem of enabling convenient and reliable control of a cleaning robot in a case of this kind, too.

With the above and other objects in view there is provided, in accordance with the invention, an apparatus for controlling a cleaning robot, wherein the cleaning robot is configured to be arranged in a service station; wherein the service station has an access opening formed to enable the cleaning robot to travels via the access opening towards the service station or away from the service station; and wherein the apparatus for controlling the cleaning robot comprises:
a controller and one or more sensors connected to said controller, said controller being configured to ascertain, on a basis of said one or more sensors, sensor data indicating whether a body part of a user is approaching the access opening and/or whether a force is acting on a gate arranged at the access opening; and
said controller being configured to operate the cleaning robot in dependence on the sensor data.

According to one aspect, an apparatus for controlling a cleaning robot is described, wherein the cleaning robot is embodied to be arranged in a service station. The cleaning robot can be embodied to execute one or more (possibly predefined) cleaning tasks. A cleaning task can respectively indicate and/or define
the spatial area (for example one or more rooms of a home), which is to be cleaned by the cleaning robot;
the type of cleaning, in particular dry cleaning and/or wet cleaning, which is to be carried out by the cleaning robot; and/or
the intensity, in particular the fan power level and/or the rotation speed and/or vibration speed of a mopping element and/or the quantity of fluid with which the cleaning is to be carried out by the cleaning robot.

Different cleaning tasks can be differentiated in relation to one of more of the above-mentioned parameters.

The service station of the cleaning robot has an access opening, which is provided so the cleaning robot travels via the access opening towards the service station, in particular towards the parking area and/or towards the docking element of the service station, or away from the service station, in particular away from the parking area and/or away from the docking element of the service station. The service station can have a gate, which can be opened or closed (on the basis of an electrically operated actuator, for instance an electric motor). The gate can be embodied to open or clear or to close or block the access opening.

The service station can be embodied to be arranged in the pedestal region between two pedestals of a cabinet, such as a kitchen cabinet or cupboard, in particular such a way that

the access opening is arranged between the two pedestals of the cabinet and/or is delimited by the two pedestals of the cabinet; and/or

the access opening corresponds to an opening in the baseboard of the cabinet, which can be closed or opened where appropriate by the gate of the service station.

The apparatus is configured to ascertain, on the basis of one or more sensors (of the service station), sensor data in relation to a body part (for example a foot), of a user approaching the access opening and/or in relation to a force acting on (i.e., force effect, for short) on a (closed) gate arranged at the access opening (for example, due to the user’s foot).

The one or more sensors can comprise at least one sensor, which is configured to capture sensor data in relation to a force effect on the gate of the service station. Exemplary sensors are least one strain gauge arranged at the gate, and/or at least one acceleration and/or force sensor arranged at the gate, and/or at least one switch.

As already stated, the gate can comprise an electrically operated actuator, for instance an electric motor, which is configured to open or close the gate. The one or more sensors can comprise at least one sensor, which is configured to capture the current and/or the voltage, which are or were induced in the actuator by the force effect on the gate.

Alternatively or in addition, the one or more sensors comprise at least one sensor which is configured to capture sensor data in relation to an approach to the access opening of the service station. Exemplary sensors are a capacitive sensor, which is arranged, in particular, at the gate of the service station, and/or a light barrier arranged at the access opening, and/or an ultrasound sensor arranged at the access opening.

The apparatus is also configured to operate the cleaning robot depending on the sensor data. The apparatus can be configured, in particular, to ascertain, on the basis of the sensor data, a control signal for actuating the cleaning robot. The cleaning robot can then be reliably and efficiently prompted to execute a function associated with the control signal, in particular a specific cleaning task, on the basis of the control signal.

An apparatus (for a service station) is thus described, which enables a user to control a cleaning robot conveniently and reliably on the basis of an approach and/or on the basis of a force effect at the access opening of the service station of the cleaning robot.

The apparatus can be configured to transmit the control signal to the cleaning robot via a tethered or wireless communication link in order to prompt the cleaning robot to execute the function associated with the control signal, in particular the cleaning task associated therewith. The control signal can be transmitted, for example, efficiently and reliably to the cleaning robot via the docking element of the service station.

The apparatus can be configured to identify, on the basis of the sensor data, a pattern of the approach and/or the force effect. A pattern can be defined, for example, by

a specific number of approaches and/or force effects which are isolated time-wise;

the duration of an approach and/or force effect which is isolated time-wise; and/or

the time interval between two approaches and/or force effects which are isolated time-wise.

The control signal for inducing the function of the cleaning robot can then be ascertained particularly reliably on the basis of the identified pattern.

The apparatus can be configured to identify, on the basis of the sensor data, a specific pattern of the approach and/or the force effect from a large number of different patterns of the approach and/or the force effect. The large number of different patterns can be associated with a corresponding large number of different control signals for a corresponding large number of different functions (for example with a large number of different cleaning tasks) of the cleaning robot via a predefined assignment function, in particular via a predefined table. The individual patterns of the large number of different patterns can differ in relation to:

the number of approaches and/or force effects which are isolated time-wise;

the duration of an approach and/or force effect which is isolated time-wise; and/or

the time interval between two approaches and/or force effects which are isolated time-wise.

The assignment function can be stored on a memory unit of the service station and/or the cleaning robot. The control signal for the specific pattern can be ascertained particularly reliably on the basis of the assignment function. Particularly convenient operation of the cleaning robot can be enabled by the identification of different patterns for different functions.

The apparatus can be configured to ascertain, via a user interface (of the cleaning robot), a user input in relation to the function and/or an extent of the function of the cleaning robot, which is associated with a specific control signal and/or with a specific pattern of the approach and/or force effect. The assignment function, in particular the table, for assigning the specific control signal and/or the specific pattern of the approach and/or the force effect to a function of the cleaning robot can then be adjusted and/or updated depending on the user input. It can thus be possible for a user to establish one or more functions, in particular cleaning tasks, which can be triggered by corresponding one or more different patterns of the approach and/or force effect. The convenience of controlling the cleaning robot can thus be further increased.

As already stated, the service station can comprise a docking element for docking of the cleaning robot. The apparatus can be configured to determine whether the cleaning robot has docked with the docking element or not. The apparatus can also be configured to operate the cleaning robot depending on the sensor data, in particular only when it is determined that the cleaning robot is docked with the docking element. The apparatus can be configured, in particular, to transmit the control signal (for triggering the function) to the cleaning robot, in particular only when it is determined that the cleaning robot is docked with the docking element. Particularly efficient and reliable control of the cleaning robot is thus induced.

With the above and other objects in view there is also provided, in accordance with a further aspect of the invention, a service station for a cleaning robot is described, wherein the service station comprises a parking area for the cleaning robot, as well as an access opening, which is provided so the cleaning robot travels via the access opening towards the parking area or away from the parking area. Furthermore, the service station comprises an apparatus for controlling the cleaning robot, which is embodied as described in this document.

According to yet a further aspect, a cleaning robot is described which comprises the apparatus described in this document.

According to again a further aspect, a system is described which comprises the service station as described. The system can also comprise a cleaning robot and/or a (kitchen) cabinet.

With the above and other objects in view there is also provided, in accordance with again another aspect of the invention, a method for controlling a cleaning robot, which is configured to be arranged in or at a service station, wherein the service station has an access opening, which is provided so the cleaning robot travels via the access opening towards the service station or away from the service station. The method comprises ascertaining, on the basis of one or more sensors, sensor data in relation to a body part of a user approaching the access opening and/or in relation to a force effect on a gate arranged at the access opening. Furthermore, the method comprises operating the cleaning robot depending on the sensor data.

It should be noted that any aspects of the apparatus described in this document and/or of the method described in this document can be combined with each other in a diverse and/or arbitrary manner. In particular, the features of the claims can be combined with each other in a diverse and/or arbitrary manner.

Other features which are considered as characteristic for the invention are set forth in the appended claims.

Although the invention is illustrated and described herein as embodied in an apparatus and a method for controlling a cleaning robot, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIGS. 1A and 1B shows an exemplary cleaning robot in different perspective views;

FIG. 1C shows exemplary components of a cleaning robot;

FIGS. 2A-2E show different views of a service station arranged in the pedestal region of a kitchen cabinet;

FIGS. 3A-3E show different views of a service station with a gate;

FIG. 4 shows a block diagram of a system for controlling a cleaning robot; and

FIG. 5 shows a flowchart of an exemplary method for controlling a cleaning robot.

### DETAILED DESCRIPTION OF THE INVENTION

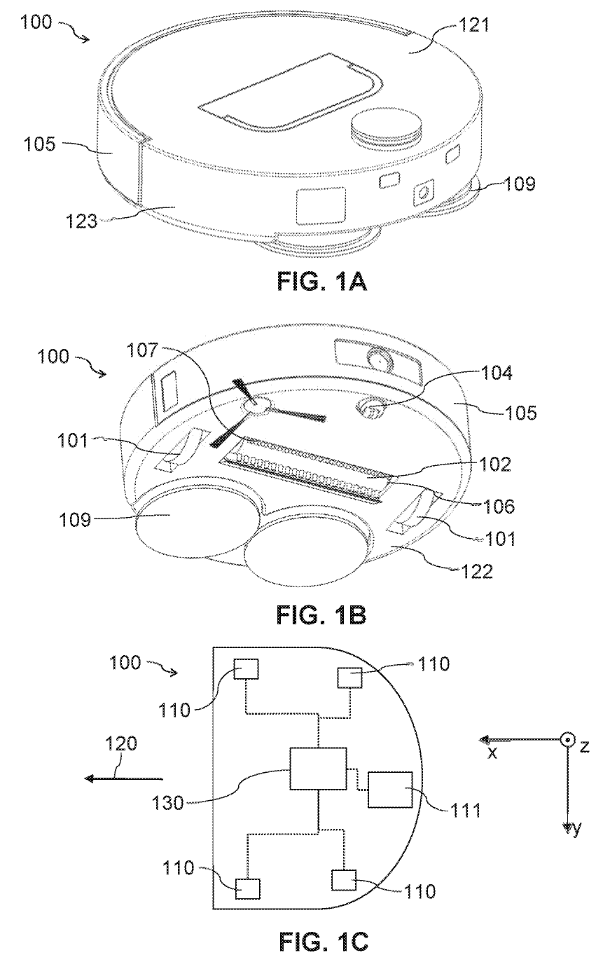

As stated in the introduction, the present document deals with enabling convenient and reliable control of a cleaning robot, in particular when the cleaning robot is arranged in a (difficult-to-access) service station. In this connection, FIG. 1A shows the top 121 and FIG. 1B shows the bottom 122 of a cleaning robot 100, in particular a suction robot.

In the suction mode of the cleaning robot 100, the bottom 122 faces the floor to be cleaned or the surface, i.e., substrate, for short, to be cleaned of a cleaning area, for instance a room in a house. The bottom 122 of the cleaning robot 100 typically has one or more drive units 101 (with one or more drive wheels), by way of which the cleaning robot 100 can be moved autonomously in order to clean different areas of a floor. Furthermore, the cleaning robot 100 can have one or more guiding and/or supporting elements 104 (for example, wheels which are not driven), which enable stable movement of the cleaning robot 100 over the floor to be cleaned. In addition, a cleaning robot 100 typically comprises one or more cleaning units 106 (in particular suction nozzles), which are each configured to clean the floor under the cleaning robot 100.

A cleaning unit 106 (in particular a suction nozzle) can have a brush roller 102, which is embodied to rotate about a rotational axis, with the rotational axis typically being arranged parallel to the bottom 122 of the cleaning robot 100. The brush roller 102 can be used to mechanically dislodge dust and/or impurities on the floor to be cleaned, from the floor, so the dust and/or the impurities can be sucked with greater reliability into the suction mouth 107 of the cleaning unit 106.

One or more mopping elements 109, in particular mopping pads, can also be arranged on the bottom 122 of the cleaning robot 100, which elements are each configured to wipe the floor to be cleaned. The cleaning robot 100 can have a water supply unit (not represented), which is embodied to supply the one or more mopping elements 109 with mopping water in each case.

A user interface can be arranged at the top 121 of the cleaning robot 100, which enables a user of the cleaning robot 100 to make control inputs. In addition, the cleaning robot 100 can comprise a bumper 105 at a side wall 123 (for example, at a side wall 123 in the front region of the cleaning robot 100), with it being possible for an impact sensor to be arranged on the bumper 105, which is configured to capture sensor data, which shows whether the cleaning robot 100 has bumped against an obstacle or not in the movement direction 120 (see FIG. 1C). Triggering of the impact sensor by an obstacle (owing to the deflection of the bumper 105) can induce, for example, the cleaning robot 100 to rotate about its vertical axis, which is perpendicular to the floor, and the movement direction 120 changes as a result in order to avoid the obstacle.

Furthermore, a cleaning robot 100 typically has one or more environment sensors 110 (see FIG. 1C), which are each configured to capture environment or sensor data in relation to the environment of the cleaning robot 100. The one or more environment sensors 110 can comprise: one or more image cameras, one or more ultrasound sensors, one or more tactile and/or optical distance sensors, one or more acoustic sensors, one or more temperature sensors, one or more lidar and/or radar sensors, etc. A control unit 130 of the cleaning robot 100 can be configured to ascertain, on the basis of the environment data, digital map information in relation to the cleaning area to be cleaned and possibly to store it on a memory unit 111 of the cleaning robot 100. The cleaning robot 100 can utilize the digital map information to independently orientate itself within the cleaning area (for example, within a room) and/or to establish a route for cleaning of the cleaning area.

FIG. 1C shows a Cartesian coordinate system with a longitudinal axis (i.e., an x-axis), with a transverse axis (i.e., a y-axis) and with a vertical axis (i.e., a z-axis). The movement direction 120 of the cleaning robot 100 typically corresponds to the longitudinal axis. The rotational axis of the brush roller 102 typically runs along the transverse axis.

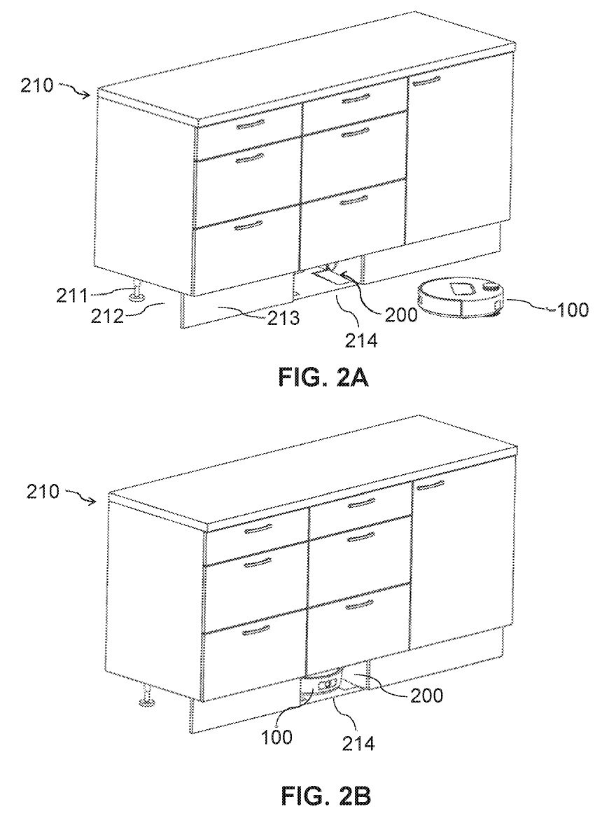

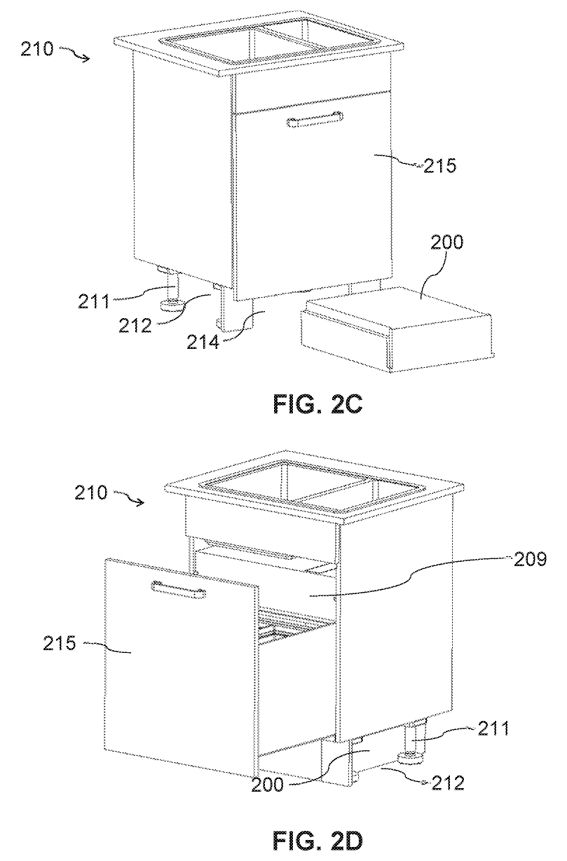

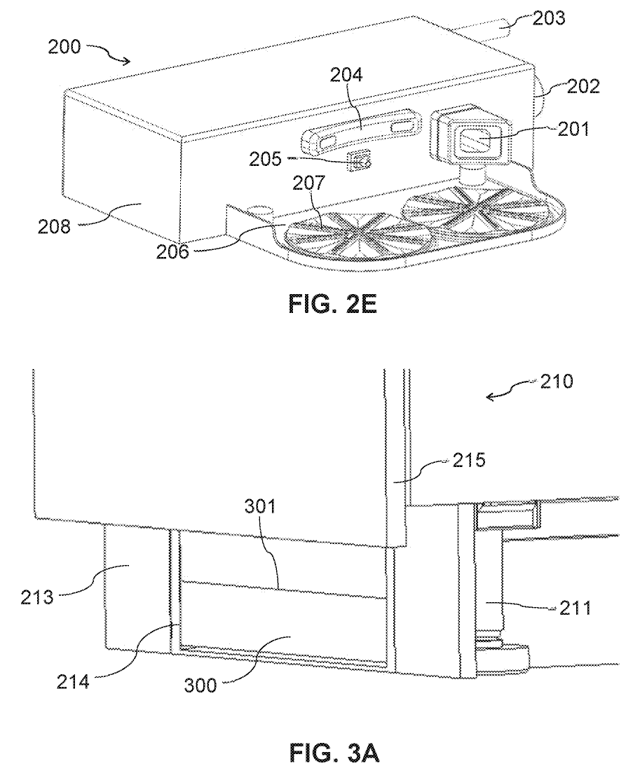

FIGS. 2A-2D show different views of a kitchen cabinet or cabinet 210 (of a built-in kitchen). The kitchen cabinet 210 stands on a plurality of pedestals 211, with it typically being possible to set the height of the individual pedestals 211, so the kitchen cabinet 210 can also be horizontally aligned on an uneven floor. The individual pedestals 211 have (at least on average) a specific pedestal height, which typically lies in the range between 5 cm and 15 cm. A kitchen cabinet 210 typically has four pedestals 211, arranged in different corners of a rectangle. At the front, a kitchen cabinet 210 also typically has at least one door 215, which is arranged above the pedestals 211 of the kitchen cabinet 210.

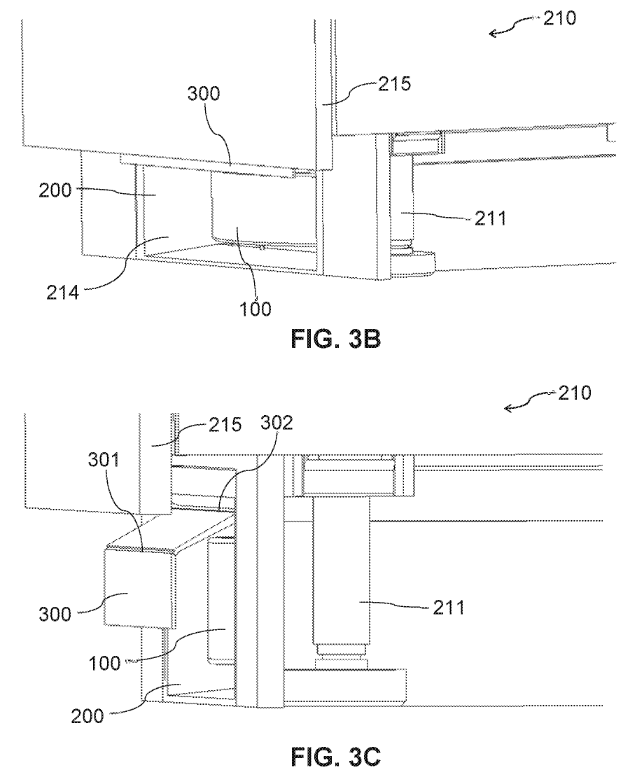

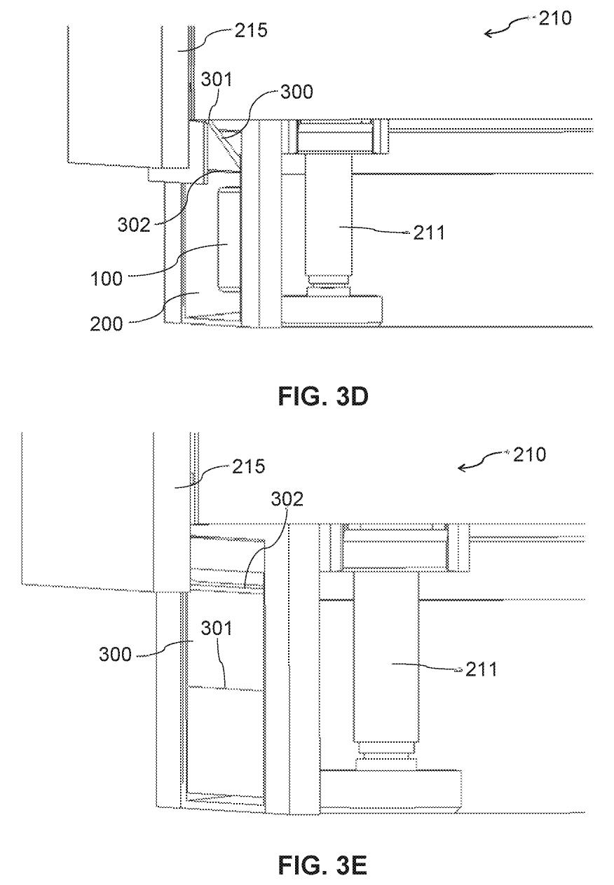

The pedestals 211, which are arranged at the bottom of the kitchen cabinet 210, thus form a clearance, which perpendicular to the floor on which the kitchen cabinet 210 stands, has a height corresponding to the pedestal height. This clearance can be referred to as the pedestal region 212. The pedestal region 212 can be used to arrange a service station 200 for a cleaning robot 100. For this purpose, the front panel 213 can have an opening 214 to cover the front of the pedestal region 212, so the service station 200 can be arranged below the kitchen cabinet 210 through the opening 214 of the front panel 213 in the pedestal region 212. The service station 200 can be open at the front side facing the opening 214, so the cleaning robot 100 can be arranged through the opening 214 at the service station 200 arranged in the pedestal region 212. In an alternative example, the service station 200 has a gate or a flap to cover the opening 214. This is shown, by way of example, in FIGS. 3A-3E.

Along the transverse axis (that is to say along the width of the cleaning robot 100, when it drives into the service station 200 or out of it), the pedestal region 212 has a specific opening width between two directly adjacent pedestals 211. The portion of the pedestal region 212 arranged between two directly adjacent pedestals 211 can be referred to as the base region. The opening 214 in the front panel 213 can have the opening width. The service station 200 can also substantially have the opening width along the transverse axis, so the service station 200 can be reliably pushed through the opening 214 into the pedestal region 212 between two directly adjacent pedestals 211 (as represented, by way of example, in FIG. 2C).

Apart from the base module arranged in the pedestal region 212, the service station 200 can have at least one further auxiliary module 209, which is arranged, for example, in a further portion of the kitchen cabinet 210, with it being possible for the portion to be arranged behind the door 215 of the kitchen cabinet 210. One or more components of the service station 200 can be arranged in the auxiliary module 209, such as the collection container for receiving the particles of dirt sucked out of the collection container of the cleaning robot 100.

The base module of the service station 200 arranged in the pedestal region 212 can have a parking area for the cleaning robot 100. Furthermore, the base module of the service station 200 can have a docking element 208 with which the cleaning robot 100 is docked when the cleaning robot 100 is arranged on the parking area of the service station 200 (see FIG. 2E). The docking element 208 can comprise:

an electrical supply interface 204 for the electrical energy supply, in particular for charging the electrical energy store, of the cleaning robot 100;

a data interface for providing a communication link between the service station 200 and the cleaning robot 100 (with it being possible for the data interface to be implemented, for example, as part of the electrical interface);

a suction removal duct 201 for cleaning by suction removal of the collection container of the cleaning robot 100; and/or

a fluid channel 205 (in particular a tank nozzle) for providing cleaning fluid, in particular mopping water, for the wet-cleaning function of the cleaning robot 100.

The parking area (of the base module) of the service station 200 can be embodied to induce cleaning of the one or more mopping elements 109 of the cleaning robot 100. For this purpose, a trough 206 can be arranged at the parking area, in which the one or more mopping elements 109 can be placed in order to clean the one or more mopping elements 109.

FIG. 2E shows an exemplary service station 200, in particular an exemplary base module of a service station 200. The service station 200 has an electrical supply interface 204, which is embodied to electrically conductively contact a complementary charging interface of the cleaning robot 100 when the cleaning robot 100 is docked with the service station 200. The electrical energy store of the cleaning robot 100 can then be charged via the supply interface 204. The service station 200 can also have a docking sensor, which is embodied to identify whether the cleaning robot 100 is docked with the base unit or not. Furthermore, the service station 200 can have a tank nozzle 205, which is embodied to connect fluidically with a complementary tank interface on the cleaning robot 100 when the cleaning robot 100 is docked with the service station 200. The fluid tank of the cleaning robot 100, from which the one or more mopping elements 109 are supplied with mopping water in each case, can then be fed with fresh water via the tank nozzle 205.

Furthermore, the service station 200, for example at the parking area for the cleaning robot 100, can have a regeneration trough 206, which is embodied to regenerate the one or more mopping elements 109 (in particular mopping pads) of the cleaning robot 100, in particular to clean them, when the cleaning robot 100 is docked with the service station 200. Starting from the docking element 208 of the service station 200, the regeneration trough 206 extends through to the docked cleaning robot 100, so the one or more mopping elements 109 of the cleaning robot 100 are arranged above the regeneration trough 206 when the cleaning robot 100 is docked with the service station 200, in particular with the docking element 208 of the service station 200. One regeneration element 207 respectively can be arranged in the regeneration trough 206 for the individual mopping elements 109 of the cleaning robot 100, and is in each case embodied to regenerate, in particular clean, the corresponding mopping element 109.

A connecting channel 202 can also be seen in FIG. 2E, via which the docking element 208 is connected to the auxiliary module 209, for example in order to guide the particles of dirt removed by suction from the collection container of the cleaning robot 100 to the collection container of the auxiliary module 209. Furthermore, the service station 200 can have one or more conduits 203, via which the service station 200 can be fluidically connected to a water supply, in particular to a permanent mains water supply. In addition, one or more further conduits can be provided in order to fluidically connect the service station 200 to a waste pipe, so dirty water can be conveyed away from the service station 200, in particular without a user’s help.

As represented by way of example in the FIGS. 3a-3e, the service station 200 can have a gate 300, which is embodied to selectively open the (access) opening 214 in the baseboard 213 (so the cleaning robot 100 can travel towards the parking area of the service station 200 or away from the parking area of the service station 200) or close it (if the cleaning robot 100 is arranged at the parking area of the service station 200, or if the cleaning robot 100 is executing a cleaning task). The gate 300 can be embodied, for example, to be pivoted about a rotational axis 302 in order to open or close the gate 300. The rotational axis 302 can run substantially parallel to the floor on which the service station 200 stands. The rotational axis 302 can, in particular, run parallel to the transverse axis. The rotational axis 302 can also be arranged at the upper edge of the opening 214 of the baseboard 213.

The gate 300 can be opened or closed by an actuator (for example, by an electric motor). The actuator can, in particular, induce the gate 300 to rotate about the rotational axis 302 in order to open or raise the gate 300 or to close or lower it.

In the example represented in FIGS. 3A-3E, the gate 300 has a folding edge 301, which runs parallel to the rotational axis 302 of the gate 300 and divides the gate 300 into a first (upper) portion and into a second (lower) portion. A rotation of the gate 300 about the rotational axis 302 makes it possible for the first portion to pivot about the rotational axis 302, so the folding edge 301 and the second portion fastened to it are raised. Furthermore, the second portion has an orientation running perpendicular to the floor (as may be seen in FIG. 3C). This kind of division of the gate 300 into a plurality of portions makes it possible for the gate 300 to be compactly arranged behind the door 215 of the kitchen cabinet 210 when the gate 300 is in the open state (as shown in FIG. 3D).

The gate 300 of the service station 200 is typically closed (that is to say transferred into the closed state), when the cleaning robot 100 is docked with the service station 200. Soiling of the pedestal region 212 of the kitchen cabinet 210 can thus be avoided. A more aesthetically pleasing appearance within a kitchen can thus also be induced. Secondly, the arrangement of the cleaning robot 100 in the pedestal region 212 of the kitchen cabinet, and, in particular, due to covering of the opening 214 of the baseboard 213 by the gate 300 of the service station 200, blocks access to the user interface of the cleaning robot 100, which makes user interaction with the cleaning robot 100 more difficult and/or hinders it, in particular when the user cannot control the cleaning robot 100 via the software app on a smartphone or tablet PC (for example, as a result of wet hands).

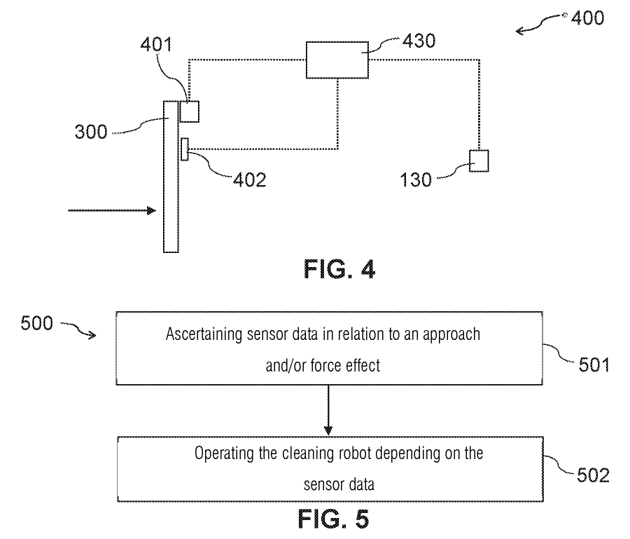

FIG. 4 shows an exemplary system 400, which enables convenient and reliable user interaction with a cleaning robot 100, which is arranged at a service station 200 with a gate 300. The system 400 comprises a (control) apparatus 430, which is configured to capture sensor data in relation to an external force, which acts on the gate 300. The external force acting on the gate 300 is represented by an arrow in FIG. 4. The external force can be induced by a user. If the service station 200 is arranged in the pedestal region 212 of a kitchen cabinet 210, the user can induce the external force, for example with their foot, in that the user kicks the gate 300 once or several times and/or in that the user exerts pressure on the gate 300 with their foot. The user can induce a specific time pattern of the external force. A time pattern of the external force can have, for example, a specific number of force pulses, with it being possible for the individual force pulses to have a specific time interval from each other.

The sensor data in relation to the external force can be captured, for example, on the basis of the actuator 401 of the gate 300. The force acting on the gate 300 makes it possible to induce a movement of the gate 300, in particular a (slight) rotation of the gate 300 about the rotational axis 302. This movement of the gate 300 makes it possible for a voltage and/or a current to be induced in the actuator 401 of the gate 300, with it being possible for the voltage and/or the current to be captured by a measuring unit (not represented) in order to provide the sensor data in relation to the external force.

Alternatively or in addition, a sensor 402 can be arranged on the gate 300 and is configured to capture sensor data in relation to the force acting on the gate 300, in particular in relation to the movement of the gate 300 induced by the force. The sensor 402 can comprise, for example, a motion sensor and/or a strain gauge and/or a pressure sensor.

The apparatus 430 can be configured to ascertain, on the basis of the captured sensor data, a control signal for controlling the cleaning robot 100 and/or for controlling the service station 200. The sensor data can indicate one or more properties of the force induced on the gate 300. Exemplary properties are:

the strength or the amplitude of the force; and/or

the time characteristic of the strength or the amplitude of the force; and/or

the number of force pulses; and/or

the time interval between two directly successive force pulses.

Alternatively or in addition, a sensor 402 can be arranged on the gate 300, which is configured to capture sensor data in relation to an approach to the gate 300. The sensor data can indicate one or more properties of an approach to the gate 300. Exemplary properties are:

the speed of the approach; and/or

the time characteristic of the speed of the approach; and/or

the number of approach pulses; and/or

the time interval between two directly successive approach pulses.

A pattern of the external force and/or the approach can thus be identified on the basis of the sensor data, which pattern was induced by a user (due to one or more kicks against the gate 300). The identified pattern can be associated with a specific control signal and/or with a specific function (of the cleaning robot 100 and/or of the service station 200). The apparatus 430 can be configured, for example, to utilize an assignment function by way of which a specific quantity of one or more different patterns is associated with a corresponding quantity of one or more different control signals. The assignment function can comprise, for example, a lookup table. The control signal can then be reliably ascertained for an identified pattern on the basis of the assignment function.

The one or more different control signals make it possible for one or more different functions of the service station 200 and/or of the cleaning robot 100 to be triggered. Via a user interface of the service station 200 and/or of the cleaning robot 100 it can be possible for the user to assign one function respectively to the one or more different control signals, which function can be triggered by the respective control signal (and the pattern associated therewith).

The apparatus 430 can be connected to the sensor 402 for capturing the sensor data via a tethered and/or a wireless data interface. The apparatus 430 can also be connected to the control unit 130 of the cleaning robot 100 via a tethered and/or a wireless data interface. The ascertained control signal can be transmitted to the cleaning robot 100 via the data interface in order to prompt the cleaning robot 100 to execute the function associated with the control signal.

A method is thus described in which a user can initiate a cleaning task for a cleaning robot 100 by the exertion of pressure or by way of a kick against the entry gate 300 of an integrated service station 200. The cleaning robot 100 can have a dry-cleaning unit (with suction mouth 107, possibly a brush roller 102, a suction fan, and possibly a side brush) and/or a wet-cleaning unit (with water tank, pump, mopping pad 109, possibly actuator for mopping pad movement). One or more interfaces can be arranged on the housing of the cleaning robot 100, which enable charging of the electrical energy store, cleaning by suction removal of the collection container and/or filling of the water tank at a service station 200.

The service station 200 can be embodied to provide one or more service functions (for example, emptying of the collection container of the cleaning robot 100 by suction removal, filling of the robot water tank with water, cleaning of the robot mopping pads 109 with water). The service station 200 can have one or more connections for a permanent water supply (fresh water, waste water). The cleaning robot 100 and the service station 200 can be embodied to communicate with each other directly or via a communication network. As described in this document, the base module of the service station 200 can be integrated in the pedestal region 212 of a kitchen unit. In this way, the cleaning robot 100 and the service station 200 can be permanently unobtrusively sited but remain ready for use at all times. The cleaning robot 100 can gain access to the service station 200 via an opening 214 in the baseboard 213. A gate 300 at the base module of the service station 200 can close or open the opening 214 in the baseboard 213 according to the situation. The gate 300 can be opened or closed on the basis of an actuator 401.

If the user kicks the gate 300 with their foot or if the user exerts pressure on the gate 300, then it is possible to identify this (on the basis of a sensor 401, 402). In response to the identified force effect on the gate 300, the cleaning robot 100 can be induced to carry out a specified cleaning action (established beforehand). This cleaning action can preferably be established and/or individually configured by the user (via a user interface). Thus, for example, the cleaning of an entire area in a home or the cleaning of a portion (for example, the kitchen or an established zone) of the home can be prompted. This configuration can be undertaken by the user, for example via the software app of the cleaning robot 100. For example, the room (for instance, the kitchen) in which the service station 200 is arranged can be established as the standard zone in a cleaning area which has not been configured.

The identification of the force acting on the gate, i.e, a force effect (for example a pressure or a kick) and/or an approach to the entry gate 300 can be identified as follows:

The entry gate 300 has at least one motor or actuator 401, which enables automatic opening and closing of the gate 300. A current measurement via measuring resistors or via an integrated current measurement can be used by the motor driver or the motor control. If, owing to the force effect against the entry gate 300, a mechanical movement is relayed to the actuator 401, generating a deviation from a rated current of the actuator 401, this process can be registered in order to identify the force effect on the gate 300.

One or more strain gauges can be used as sensors 402, which are located at one or more different locations along the entry gate 300, preferably (not visible from outside) in the interior of the service station 200. The one or more strain gauges register the force effect (in particular the pressure) against the gate 300 and via a connected controller, which, for example, is separately integrated or fastened to the electronics of the service station 200, relay the signal for starting the specific cleaning task of the cleaning robot 100.

One or more capacitive sensors 402 (for example, in the interior of the service station 200) can be used. The foot of the user approaching the entry gate 300 can induce a measurable change in capacitance, by which the user action can be identified. In this case, the approach can be identified without the exertion of a pressure or a force against the gate 300 on the part of the user.

One or more sensors 402 can be used, which can identify, for example, a pressure, bending or a foot movement or a “penetration” of the foot at the gate 300. Thus, for example, a type of “measuring panel” in the form of one or more light barriers and/or ultrasound sensors can be arranged above the entry gate 300 on the outside of the service station 200. A signal can be activated as soon as the user moves their foot close to the entry gate 300. In this case, identification can take place without the exertion of a specific pressure or a force against the gate 300 on the part of the user.

FIG. 5 shows a flowchart of a (possibly computer-implemented) method 500 for controlling a cleaning robot 100, which is embodied to be arranged in a service station 200. The service station 200 has an access opening 214, which is provided so the cleaning robot 100 travels via the access opening 214 towards the service station 200, in particular towards the parking area and/or towards the docking element 208 of the service station 200, or away from the service station 200, in particular away from the parking area and/or away from the docking element 208 of the service station 200. The service station 200 can have a movable gate 300, which can be opened or closed by an actuator 401 (in order to open or close the access opening 214). The method 500 can be executed by a (control) apparatus 430 of the service station 200.

The method 500 comprises ascertaining 501, on the basis of one or more sensors 402, sensor data in relation to a body part, in particular a foot, of a user approaching the access opening 214 and/or in relation to a force effect on the (closed) gate 300 arranged at the access opening 214. Exemplary sensors 402 are: a (capacitive) proximity sensor, a light barrier, an ultrasound sensor, a strain gauge, and/or an ultrasound sensor. The actuator 401 (for instance, a current measurement and/or voltage measurement of the actuator 401) of the gate 300 can possibly be used to capture the sensor data.

The sensor data can indicate a specific pattern of the approach and/or the force effect. The pattern can have, for example, one or more (possibly pulse-like) approach(es) and/or force effects. On the basis of the sensor data it is possible to identify that a specific pattern of the approach and/or the force effect was induced.

The method 500 also comprises operation 502 of the cleaning robot 100 depending on the sensor data, in particular depending on the identified pattern of the approach and/or the force effect. For this purpose, a control signal can be transmitted from the service station 200 to the cleaning robot 100 (for example, via a data interface of the docking element 208 of the service station 200). A specific function, in particular a specific cleaning task, can then be executed by the cleaning robot 100.

The measures described in this document enable efficient, convenient and reliable control of a cleaning robot 100 arranged in a service station 200.

It will be understood that the present invention is not limited to the disclosed exemplary embodiments. In particular, it should be noted that the description and the Figures are intended to only demonstrate the principle of the apparatus described in this document and/or of the method described in this document.

The following is a summary list of reference numerals and the corresponding structure used in the above description of the invention:

100 cleaning robot

101 drive unit

102 brush roller

104 guiding and/or supporting element

105 bumper

106 cleaning unit / suction nozzle

107 suction mouth

109 mopping element

110 environment sensor

111 memory unit

120 movement direction / longitudinal direction

121 top

122 bottom

123 side wall

130 control unit

200 service station

201 suction channel

202 connecting channel

203 duct

204 electrical supply interface

205 tank nozzle

206 regeneration trough

207 regeneration element

208 docking element

209 auxiliary module

210 (kitchen) cabinet

211 pedestal

212 pedestal region

213 front panel

214 opening (front panel)

215 cabinet door

300 gate

301 folding edge

302 rotational axis

400 system

401 actuator (gate)

402 sensor

430 control apparatus, controller

500 method for controlling a cleaning robot

501 method step

502 method step

1. An apparatus for controlling a cleaning robot, wherein the cleaning robot is configured to be arranged in a service station; wherein the service station has an access opening formed to enable the cleaning robot to travels via the access opening towards the service station or away from the service station; and wherein the apparatus for controlling the cleaning robot comprises:
a controller and one or more sensors connected to said controller, said controller being configured to ascertain, on a basis of said one or more sensors, sensor data indicating whether a body part of a user is approaching the access opening and/or whether a force is acting on a gate arranged at the access opening; and
said controller being configured to operate the cleaning robot in dependence on the sensor data.

2. The apparatus according to claim 1, wherein said controller is configured:
to ascertain, on a basis of the sensor data, a control signal for actuating the cleaning robot; and
to prompt the cleaning robot, on a basis of the control signal, to execute a function associated with the control signal.

3. The apparatus according to claim 2, wherein said controller is configured to transmit the control signal to the cleaning robot via a tethered or wireless communication link in order to prompt the cleaning robot to execute a function associated with the control signal.

4. The apparatus according to claim 2, wherein said controller is configured:
to identify, on a basis of the sensor data, a pattern of an approach by the user and/or the force acting on the gate; and
to ascertain the control signal based on the pattern so identified.

5. The apparatus according to claim 4, wherein said controller is configured:
to identify, based on the sensor data, a specific pattern of the approach and/or the force from a multitude of different patterns of the approach and/or the force; wherein the multitude of different patterns is associated with a corresponding multitude of different control signals for a corresponding multitude of different functions of the cleaning robot via a predefined assignment function, being a predefined table; and
to ascertain the control signal for the specific pattern on a basis of the assignment function.

6. The apparatus according to claim 5, wherein individual patterns of the multitude of different patterns are different in relation to at least one of the following:
a number of approaches and/or of force impacts which are isolated time-wise;
a duration of an approach and/or of an acting force which is isolated time-wise; or
a time interval between two approaches and/or acting forces which are isolated time-wise.

7. The apparatus according to claim 2, wherein said controller is configured:
to ascertain via a user interface a user input in relation to at least one of the function or an extent of the function of the cleaning robot which is associated with at least one of the control signal, or with a specific pattern of the approach or the force acting on the gate; and
to adjust an assignment function, being a table, for assignment of at least one of the control signal or a specific pattern of the approach or the force to a function of the cleaning robot depending on the user input.

8. The apparatus according to claim 2, wherein:
the function of the cleaning robot is a cleaning task to be executed by the cleaning robot; and
the cleaning task indicates at least one of the following:
a spatial area to be cleaned by the cleaning robot;
a type of cleaning to be carried out by the cleaning robot; or
an intensity of the cleaning is to be carried out by the cleaning robot.

9. The apparatus according to claim 8, wherein:
the type of cleaning to be carried out by the cleaning robot is selected from the group consisting of dry cleaning and wet cleaning; and
the intensity of the cleaning is selected from the group consisting of a fan power level, a rotation speed of a mopping element, a vibration speed of the mopping element, and a quantity of fluid with which the cleaning is to be carried.

10. The apparatus according to claim 1, wherein
said one or more sensors comprise at least one sensor that is configured to capture sensor data in relation to a force acting on the gate of the service station; and
said one or more sensors are selected from the group consisting of at least one strain gauge arranged at the gate; at least one acceleration sensor arranged on the gate, a force sensor arranged at the gate; and at least one switch.

11. The apparatus according to claim 1, further comprising:
an electrically operated actuator associated with the gate and configured to open or close the gate; and
said one or more sensors comprise at least one sensor that is configured to capture at least one of a current or a voltage induced in said actuator by the force acting on the gate.

12. The apparatus according to claim 1, wherein:
said one or more sensors comprise at least one sensor configured to capture sensor data in relation to an approach to the access opening of the service station; and
said one or more sensors are selected from the group consisting of a capacitive sensor arranged at the gate of the service station; a light barrier arranged at the access opening; and an ultrasound sensor arranged at the access opening.

13. The apparatus according to claim 1, wherein:
the service station comprises a docking element for docking the cleaning robot; and
the controller is configured:
to determine whether the cleaning robot has docked at said docking element; and
to operate the cleaning robot depending on the sensor data, only when the cleaning robot has docked at the docking element.

14. A service station for a cleaning robot, the service station comprising:
a parking area for the cleaning robot;
an access opening configured to enable the cleaning robot to travels via the access opening towards said parking area or away from said parking area; and
an controller according to claim 1 for controlling the cleaning robot.

15. The service station according to claim 14, configured to be arranged in a pedestal region between two pedestals of a cabinet, wherein:
the access opening is formed between two pedestals of the cabinet or is delimited by the two pedestals of the cabinet; and/or
the access opening is to an opening in a baseboard of the cabinet, and the gate of the service station is configured to close or open the opening.

16. A method for controlling a cleaning robot, which is configured to be arranged in a service station; wherein the service station has an access opening, which is provided so the cleaning robot travels via the access opening towards the service station or away from the service station; wherein the method comprises
ascertaining, on a basis of one or more sensors, sensor data in relation to a body part of a user approaching the access opening and/or in relation to a force acting on a gate arranged at the access opening; and
operating the cleaning robot depending on the sensor data.
